(19) United States
(12) Patent Application Publication
(10) Pub. No.: US 2025/0018792 A1
(43) Pub. Date: Jan. 16, 2025

(54) MULTIFUNCTIONAL OPERATING DEVICE FOR A MOTOR VEHICLE, AND MOTOR VEHICLE

(71) Applicant: Volkswagen Aktiengesellschaft, Wolfsburg (DE)

(72) Inventors: Martin Hofmann, Lehre (DE); Wojciech Huwer, Braunschweig (DE); Henning Thiele, Wolfsburg (DE)

(21) Appl. No.: 18/713,593

(22) PCT Filed: Nov. 7, 2022
(86) PCT No.: PCT/EP2022/080991

§ 371 Date: May 24, 2024

(30) Foreign Application Priority Data
Dec. 3, 2021 (DE) 10 2021 213 760.1

(51) Int. Cl. B60K 35/10; B60K 35/21; B60K 35/22; B60K 35/26; B60K 35/28; G06F 3/02; G06F 3/0484; G06F 3/16

(52) U.S. Cl. CPC B60K 35/10; B60K 35/212; B60K 35/22; B60K 35/26; B60K 35/28; G06F 3/02; G06F 3/0484; G06F 3/165; B60K 2360/1438; B60K 2360/164

(57) ABSTRACT

Technologies and techniques directed to a multifunctional operating device for a motor vehicle and a motor vehicle equipped with such a device. The operating device includes a multifunctional operating element for operating a plurality of predefined functions. These predefined functions include setting a volume for an acoustic output through a loudspeaker device and setting a driving experience. A driving operation mode and an ambience mode of the motor vehicle can be set using the operating element to customize the driving experience.

### RELATED APPLICATIONS

The present application claims priority to International Patent Application No. PCT/EP2022/080991 to Hofmann et al., filed Nov. 7, 2022, titled “Multifunctional Operating Device For A Motor Vehicle, And Motor Vehicle,” which claims priority to German Pat. App. No. DE 10 2021 213 760.1, filed Dec. 3, 2021, to Hofmann et al., the contents of each being incorporated by reference in their entirety herein.

### TECHNICAL FIELD

The present disclosure relates to a multifunctional operating device for a motor vehicle and to a motor vehicle equipped with such an operating device.

### BACKGROUND

Today's motor vehicles are becoming increasingly more complex and frequently have a multitude of functions and setting options for a user. At the same time, today's multifaceted technical possibilities seem an obvious choice for implementing various designs of operating elements, for example conventional buttons or knobs as well as touch screens, that is touch-sensitive screens, and/or the like. However, a driver of a motor vehicle may become distracted by a manual operation of functions as well as by a confusing variety of functions and operating elements. In addition, typically only limited installation space is available for arranging operating elements. This creates the challenge of making a variety of different functions of a motor vehicle easy and safe for the driver to operate.

One example of an operating concept is described in US 2004/0 118 664 A1. There, a multifunction switch is provided for choosing a system mode and for selectively adjusting a parameter associated with the chosen system mode. The switch comprises a switch body, at least a portion of which is configured to be rotate about an axis to actuate the switch in a first manner. The switch body is furthermore configured to actuate the switch in a second manner that differs from the first manner. The switch moreover comprises a display portion for displaying system mode information.

US 2017/0 153 718 A1 describes a human-machine interface for a vehicle as another example. This system comprises a configurable display to selectively display a first display configuration and a second display configuration. The system also includes a knob that is repositionable along the display between a first position and a second position. The system is configured to display the first display configuration when the knob is in the first position and to display the second display configuration when the knob is in the second position. With this, an improved control system for a vehicle is to be provided, which is able to minimize a distraction of a driver.

As another example, U.S. Pat. No. 2,018,164 903 AA describes a control knob for controlling an operation of a machine. The control knob there comprises an attachment member for attaching the control knob to a surface of the machine, a display member, a controller for controlling a display of an operating mode of the machine by means of the display element, and an operational mode selector for controlling a selection of an operating mode of the machine when this operating mode is being displayed by means of the display element.

### SUMMARY

Aspects of the present disclosure are directed to enabling a simplified and improved operability of a motor vehicle.

Some aspects of the present disclosure are provided in the subject matters of the independent claims, found below. Other aspects are disclosed in the subject matter of the respectively associated dependent claims, the description and the figures.

In some examples, a multifunctional operating device, configured for a motor vehicle, is disclosed. The multifunctional operating device, (also referred to herein as “operating device” for short), can thus be installed in a motor vehicle as intended. The operating device comprises a multifunctional operating element, (also referred to herein as “operating element” for short), for operating several different predefined functions. It is thus possible by means of the operating element to operate, and/or control, set or activate, several predefined functions, in particular several predefined functions of the motor vehicle, at least in the intended installation position of the operating device in the motor vehicle.

In some examples, a motor vehicle is disclosed, comprising an operating device according to the present disclosure. The motor vehicle may be the motor vehicle described in connection with the operating device according to the present disclosure, or correspond thereto. Accordingly, the motor vehicle according to the present disclosure can have several or all properties, embodiments and/or features described in connection with the operating device disclosed herein.

Further features can be derived from the following description of the figures and based on drawing. The features and feature combinations mentioned herein, can be used not only in the respectively indicated combination, but also in other combinations, or alone, without departing from the scope of the disclosure.

### DESCRIPTION OF THE DRAWINGS

In the drawings:

FIG. 1 shows a schematic representation to illustrate an operating concept for a motor vehicle, according to some aspects of the present disclosure; and

FIG. 2 shows a schematic partial representation of a motor vehicle comprising a corresponding operating device, according to some aspects of the present disclosure.

### DETAILED DESCRIPTION

Like or functionally equivalent elements are denoted by like reference numerals in the figures.

Operating a function within the present disclosure may, for example, denote or encompass activating, setting, or adjusting an option, particularly one of several predefined, choosable, or selectable options assigned to the function.

The predefined functions that can be operated in the intended installation position of the operating device by means of the operating element include setting a volume for an acoustic output by means of a loudspeaker device and setting a driving experience. Using the operating element, a volume or output volume of media playback, an infotainment display, voice output from a navigation device, a voice assistant, a telephone call, or similar can be set or changed by a user, particularly a driver of the motor vehicle.

For setting the driving experience, a driving operation mode and an ambience mode, which pertains to the vehicle's interior atmosphere, can be set by a user, particularly the driver, using the operating element, in the intended installation position of the operating device.

In other words, the multifunctional operating device according to the present disclosure is configured to set both the volume and the driving operation mode and the ambience mode using a single operating element, making these functions operable for a user, particularly a driver of the motor vehicle. For the volume setting function, multiple adjustable options or values may be predefined, encompassing different volume settings or even muting the acoustic output by means of the loudspeaker device, which can be part of the vehicle's infotainment system. For the driving experience setting function, multiple different adjustable options or values can be predefined, encompassing various predefined driving operation modes and ambience modes. Driving operation modes can include sports mode, comfort mode, and eco mode, each defining specific settings or parameter values for multiple devices of the motor vehicle influencing its driving behavior. These settings can include maximum service levels, acceleration behavior, chassis or suspension tuning, and steering device directness.

The ambience modes can encompass settings or parameter values for one or more devices of the motor vehicle, influencing non-driving-related atmosphere or ambience functions. These can include lighting in the passenger compartment, air conditioning, media or music selection, and similar functions, ultimately setting different atmospheres or moods in the vehicle's passenger compartment by appropriately activating the vehicle's devices.

The operating device can be configured to operate multiple functions organized in a hierarchical structure or menu levels. At each level, functions can be selected and their options or values set using the operating element. The device can also switch between menu levels, allowing selection of adjacent or predefined standard levels.

For example, using the operating element, one can switch from a volume setting level to a driving experience setting level. At this level, functions for setting or selecting the driving profile and ambience mode can be accessed directly. The function for setting the volume can be directly superordinate or operable at the same level as the driving experience setting functions. All described functions can be operated using the same physical operating element, including further predefined functions like setting the tint of an electrically tintable window, possibly retrofittable or enabled via software updates.

According to a finding on which the present disclosure is based, the functions for setting the volume and the driving experience described here, that is, the driving operation mode or driving profile and the ambience mode, are related in terms of the topic or in terms of their significance, both logically and intuitively for many users. The described functions or their operability by means of the same operating element, that is, the corresponding assignment of these functions to the operating element, allow the usage experience for a user during the operation of the motor vehicle to be adapted particularly easily and comprehensively. This is especially clear since the volume can be set independently of the driving experience. In contrast to existing solutions, the user here does not have to use different operating elements or devices, or different buttons or knobs, to comprehensively adapt the usage experience. Moreover, the described embodiments of the present disclosure can enable especially rapid operation or setting of both the volume and the driving experience, since it is not necessary to navigate through completely separate logical or hierarchical menu levels or to utilize different operating elements or devices. Rather, the functions for setting the volume and the driving experience can be arranged or accessible within the same structure.

Overall, the present disclosure thus makes it possible to carry out the different described settings especially quickly and with minimal potential for distraction, thus enhancing safety. The described functions or settings are especially person-dependent and situation-dependent, so there is a relatively high likelihood that these settings or functions will be changed relatively frequently by a user, or by various users, of the motor vehicle compared to other functions or settings of the motor vehicle. For example, less distinct person-specific preferences may typically exist for a function such as setting a switch-off delay time of an auxiliary lighting system after an operating action, such as closing a door or hatch of the motor vehicle, has been carried out. Moreover, such a function or setting may be less dependent on the situation. For such a setting, a predefined standard setting is more readily accepted and maintained by many users or is typically only carried out once by a certain user according to an individual preference and will then be permanently maintained regardless of the situation. For such a function, a higher operating complexity may be justified without an individually assigned physical operating element and without linking the operation to other functions. Such a grouping or categorization of the functions of the motor vehicle, and in particular the combination or assignment of the described functions to the shared operating element, as described in the present disclosure, may thus allow a compromise between especially rapid operability of all functions by individual physical operating elements on the one hand, and a practicable limitation of the number of physical operating elements with particularly high effective usage comfort on the other hand.

The operating device according to the present disclosure can comprise at least one actuator for generating at least one piece of haptic feedback. For example, the operating device can be configured to automatically generate a respective piece of haptic feedback, such as a vibration, at the operating element in response to one or more specified trigger events. Different pieces of haptic feedback, such as different vibration patterns or durations, may be predefined for different trigger events. For example, an actuation of the operating element, which in particular is successful in terms of triggering a predefined function, such as successfully changing, selecting, or setting a menu or operating level, a function, and/or an option or value of a function, can be specified or defined as trigger events. Such haptic feedback can make it possible for a user to reliably operate the functions linked to or operated with the operating element or the operating device without looking. This can enhance safety since the user does not have to avert their gaze as frequently from their surroundings, such as the surrounding traffic situation.

In some examples, the operating device is configured to return to a predefined standard operating mode after a predefined time period has elapsed following the last operation of a function that differs from the volume setting, if no further operation of the operating element or a function that differs from the volume setting is carried out within the time period. The volume can be set directly in this standard operating mode. In other words, the volume can be changed directly in the standard operating mode by a single actuation of the operating element, without first selecting the volume setting function or switching from the most recently used menu or operating level to the level where the volume setting function is located. After setting the driving experience or navigating into the level where at least one aspect of the driving experience or a function differing from the volume setting can be operated or selected, the volume setting function is always automatically selected after the predefined time period elapses. This improves usage comfort in two ways: first, the volume is changed more frequently than the driving experience, making it especially easy and fast for the user; second, the user can always start from the same point in the predefined menu or operating level structure after the predefined time period elapses. This saves the effort of determining which point or place in the structure is currently selected to choose or reach a certain function. This makes it easier for the user to operate the operating element or the functions linked to it without looking, reducing potential distractions and enhancing safety. The predefined time period can range from 3 to 10 seconds, or other values can be specified or settable.

In some examples, the operating device comprises at least one light or luminous element arranged at the operating element. Each of the different predefined functions has a luminous or light color assigned to it, specifically a certain hue of the light output by the luminous device. The operating device is configured to activate the luminous element based on the function currently chosen or selected for operation, illuminating it in the light color assigned to that function. In other words, the luminous element, through its light color, can always signal to the operating device which function is currently selected for operation and can be directly operated by the actuation of the operating element. This allows the user to easily and with minimal distraction identify the currently selected function, particularly through peripheral vision. This setup reduces the need for the user to look away from the surrounding traffic situation to ascertain the currently set function, thus enabling especially easy and reliable operation of the different predefined functions.

The luminous element may be part of the operating element and can be arranged, for example, at a fixed part of the operating element that is immovable relative to the housing of the operating device or, in the intended installation position in the motor vehicle, relative to the vehicle's interior, and does not need to be moved or adjusted to operate the function. Alternatively, the luminous element can be arranged at a movable part of the operating element, which can be moved or adjusted to operate at least one of the functions. In this case, the luminous element moves together with this part of the operating element relative to the housing of the operating device or the vehicle interior. The luminous element can also be a separate device of the operating device, possibly arranged next to or in a ring-like manner around the operating element.

Different options or values of one or more predefined functions can be assigned different color saturations or brightness levels of the particular light color. These can be automatically set by the operating device based on the currently selected option or value. As a result, visual feedback is provided to the user not only about the currently selected function but also about the current setting or status of that function. This enhances the recognizability of the current setting and successful actuation of the operating element, ultimately decreasing distraction and improving safety.

In some examples, the operating element can be actuated in several different manners. The operating device is configured to switch between at least two predefined functions or menu levels, or the selected or directly operable function, in response to a first manner of actuation of the operating element. It can switch between different predefined options or values of the currently selected function in response to a second manner of actuation. For example, the first manner might involve pushing a part of the operating element along an axis, while the second manner might involve rotating the same or another part of the operating element about this axis. Other manners of actuation, such as moving, touching, or swiping on a touch-sensitive surface, can also be provided. This allows for intuitive operation of multiple functions and easy navigation through menu levels using a single operating element, reducing attention demands and enhancing safety.

In some examples, the predefined functions, operable by means of the operating element, are structured in multiple levels, each level allowing at least one function to be operated. The operating element here is designed as a rotary/push button controller. The operating device can switch between levels in response to a push actuation along a predefined axis and switch between functions of the same level in response to a swiping or touch actuation on a touch-sensitive region of the operating element. It can cycle through options or values of the currently selected function in response to a rotating actuation. This setup provides an intuitive and comfortable user experience, reducing the risk of faulty or dual actuations and contributing to improved safety and usage comfort. If only two operating levels are defined, switching between them can be done by repeated push actuations. If more than two levels are defined, switching can be done in an ascending, descending, or cyclical manner.

In some examples, the operating device includes an infotainment display for the motor vehicle, which is spaced apart from or connected to the operating element in the vehicle. This infotainment display can be a touch-sensitive screen used for other functions not operable by the operating element and may have a screen size ranging from 4 to 16 inches or more. The operating device generates a control signal for each actuation of the operating element and transmits it to the infotainment display, possibly via a direct link or the vehicle's onboard electrical system. The control signal activates the infotainment system to visualize the selection or setting made by the actuation of the operating element. This allows the effect of the completed actuation to be visually represented on the infotainment display, typically arranged so that the driver can detect displayed content quickly without looking away from the road. This enables safe and reliable operation, even for users unfamiliar with the function structure of the operating element, and allows for effective blind operation.

In some examples, the infotainment display is a touch screen. The operating device can activate the infotainment display to simultaneously show operating symbols for multiple predefined functions at a menu level selected by the actuation, or for multiple predefined options or values of the currently selected function. This enables direct selection, adjustment, or activation by touching the respective operating symbol, without cycling through multiple functions or options using the operating element. This facilitates fast and easy operation, especially for multiple functions or numerous options, reducing overall operation time. It also minimizes the time a user's hand stays away from the steering wheel, enhancing safety and usage comfort, as multiple options or values, including active settings, are clearly conveyed via the infotainment display.

In some examples, the operating element includes an integrated display region. The operating device activates this display region to visualize the function currently selected for operation and the current selection or setting of an option or value. The currently operable function or a preselected function that has not yet been confirmed can be visualized. Similarly, the current option or value of the function can be visualized, independently or before it is activated. This provides visual feedback directly at the operating element, facilitating an intuitive understanding of the current state of the operating element, the operating device, or the operable functions. This visual feedback is available at all times, even when the infotainment display shows other content, ensuring safe and reliable usage of the operating device and linked functions.

In some examples, the operating device is configured to visualize functions and current selections of options or values in the display region using both symbols and words. Symbols can be predefined, while words can be represented by words, acronyms, abbreviations, or letters. This dual visualization method helps users, especially those unfamiliar with the device, to use it reliably and accurately. It also allows for quick, low-distraction operation, as symbols are often grasped more quickly and reliably through peripheral vision.

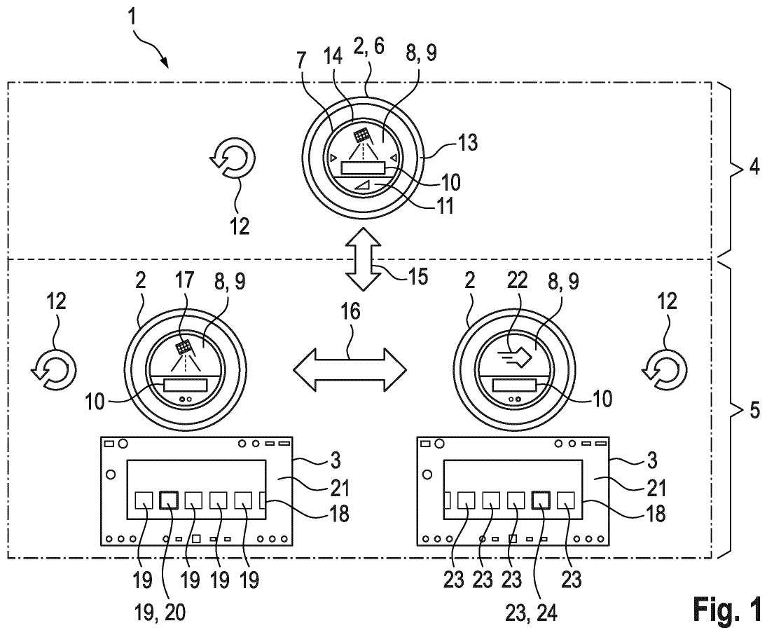

Turning to FIG. 1, the drawing shows a schematic overview representation to illustrate an operating model 1 of an operating device for a vehicle. The operating device here comprises an operating element 2, which can in particular be embodied as a rotary/push button controller. The vehicle or the operating device furthermore comprises an infotainment display 3 coupled to the operating element 2. Various possible states of the operating element 2 and of the infotainment display 3 are shown here by way of example, which can be achieved or set by corresponding actuations of the operating element 2. These actuations are represented here by corresponding arrows.

The operating model 1, by way of example, has two logical or hierarchical menu or operating levels, which here are represented as a first operating level 4 and as a second operating level 5. A setting of a volume of an acoustic output in the particular vehicle is assigned or allocated as a function to the first operating level 4. A setting of a driving experience is allocated to the second operating level 5. Multiple functions are provided organizationally or logically at the second operating level 5. In the present example, these encompass a function for a driving profile setting, that is, a driving operation mode setting, and a function for an ambience mode setting of the particular vehicle.

The operating element 2 here comprises an outer fixed region, which is not movable and thus, in the intended installation position in the particular vehicle, also remains, for example, in a fixed location or position relative to a frame or vehicle interior of the vehicle upon an actuation of the operating element 2. The operating element 2 furthermore comprises an operating region 7, which may be movable relative to the fixed region 6. For example, the operating region 7 can be pushed and/or pulled along an operating axis that is perpendicular to the drawing plane as well as be turned or rotated about this axis, that is, in the drawing plane. A display region 8 is provided here at the operating region 7. This display region 8 can be or encompass a display, in particular on or at a head side or end face of the operating element 2 or of the operating region 7.

At the first operating level, when the function for setting the volume is selected or active, the display region 8 can, for example, be divided, logically or for a shown visualization, into a symbol region 9, a text region 10 and a volume region 11. In the symbol region 9, a predefined symbol may be displayed for a respective current driving profile and/or ambience mode setting. In the text region 10, this setting can be indicated by a corresponding word-like, letter-based or textual representation. A respective current volume setting can be visualized in the volume region 11. With this, it is additionally visualized or conveyed that currently the function for setting the volume is selected, that is, can be directly operated, for example by a rotary actuation 12 of the operating region 7 illustrated schematically here.

The operating element 2 here also comprises an outer luminous element 13 and an inner luminous element 14. These luminous elements 13, 14 can be automatically activated so as to visualize, that is, display or represent, a respective currently selected function and/or a respective current or selected option or a respective current or respective currently selected value of the function in accordance with a predefined color assignment. For example, the luminous elements 13, 14 can be illuminated in different hues, depending on which function and/or which option or which value is currently set or selected in each case. Moreover, when the function for setting the volume is selected, the volume region 11 may be highlighted by being illuminated, while the symbol region 9 and the text region 10 may, in contrast, be dimmed.

For example, it is possible to switch between the first operating level 4 and the second operating level 5 by a push actuation 15 of the operating element 2, in particular of the operating region 7. In addition, it is provided here that the operating device, after a predefined time period has elapsed without interruption, automatically returns to the first operating level 5, that is, to the function for setting the volume, after an actuation or operation at the second operating level 5 or an operating level that differs from the first operating level 4.

After a switch to the second operating level 5, a, for example tapping or swiping, touch actuation 16 of the operating element 2, in particular of the operating region 7, can be used to switch between the functions for the driving profile setting, illustrated on the left here, and for the ambience mode setting, illustrated on the right there.

If the function for the driving profile setting is selected, this can be visualized by appropriate visualization in the display region 8 as well as a corresponding change in the color or hue of the outer luminous element 13 and/or of the inner luminous element 14. For example, a driving profile symbol 17, which represents a respective currently selected driving profile 19, can be displayed in the symbol region 9, and a predefined assigned letter combination, such as, for example, “Sports”, “Comfort”, “Eco” or the like, can be displayed in the text region 10, and in particular be highlighted by being illuminated compared to the representation or visualization at the first operating level 4, that is, when the function for setting the volume is selected. At the same time, a driving experience region 18 can be displayed corresponding thereto by means of the infotainment display 3. In this driving experience region 18, it is possible to display multiple or all available driving profiles 19 as well as a current driving profile setting or driving profile selection 20 when the function for setting the driving profile 19 is selected. In this way, multiple or all of the available driving profiles 19 can be made directly accessible, that is, selectable or activatable. The individual driving profiles 19 can be cycled through incrementally by a rotary actuation 12 of the operating element 2 or be selected or activated by contact with the corresponding operating symbol on the infotainment display 3.

The infotainment display 3 can be used for a plurality of other functionalities. This is illustrated here by a background region 21 in which further functionalities, settings, data or pieces of information in particular not directly linked with the operating element 2 can be visualized.

If a switch to the function for the ambience mode setting is made by a touch actuation 16, this can possibly be visualized or displayed by an accordingly adapted light or luminous color of the outer luminous element 13 and/or of the inner luminous element 14. In addition or as an alternative, this can be visualized in the display region 8, for example. For this purpose, an ambience mode symbol 22 can be represented in the symbol region 9, for example, which represents or displays the respective currently selected ambience mode 23. Likewise, a corresponding assigned predefined letter combination can be displayed in the text region 10, which identifies, that is, indicates, the respective current or currently selected ambience mode 23. Corresponding to this, multiple or all available ambience modes 23 can be represented by corresponding operating symbols analogously to the predefined driving profiles 19 by means of the infotainment display 3 in the driving experience region 18 when a switch is made to this function. It is also possible for a current or currently selected ambience mode 19, that is, a corresponding ambience mode selection 24, to be visualized, for example by highlighting in an appealing manner or the like. For example, it is possible to switch between the predefined ambience modes 23 here by a rotary actuation 12 of the operating element 2 or of the operating region 7.

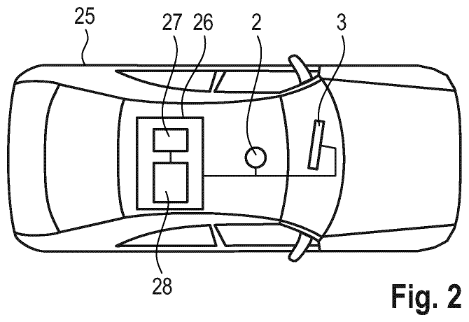

FIG. 2 shows a schematic representation of a motor vehicle 25 for further illustration. This motor vehicle 25 can, in particular, be the aforementioned vehicle. The motor vehicle 25 here is thus equipped with the operating device. For implementing the described functionalities, the operating device can comprise a data processing device 26. This data processing device 26 here comprises a processor 27, that is, for example, a microchip, a microprocessor, a microcontroller or the like, and a data memory 28 connected thereto. A predefined operating or computer program can be stored on the data memory 28, which can be executable by the processor 27 in order to implement the described functionalities or processes. The data processing device 26 is connected via a data link, for example a direct link or an onboard electrical system of the motor vehicle 20, to the operating element 2 and the infotainment display 3. In this way, operating signals generated by actuations of the operating element 2 can reach the data processing device 26 and be detected and processed there. Thereupon, corresponding control signals for activating the operating element 2 and/or the infotainment display 3 can be generated by the data processing device 26 and be emitted.

Overall, the described examples show how a system for controlling a volume, a driving profile setting and an ambience or atmosphere setting can be implemented with a shared operability at one location or by means of a single physical operating element 2.

### LIST OF REFERENCE NUMERALS

1 operating model
2 operating element
3 infotainment display
4 first operating level
5 second operating level
6 fixed region
7 operating region
8 display region
9 symbol region
10 text region
11 volume region
12 rotary actuation
13 outer luminous element
14 inner luminous element
15 push actuation
16 touch actuation
17 driving profile symbol
18 driving experience region
19 driving profile
20 driving profile selection
21 background region
22 ambience mode symbol
23 ambience mode
24 ambience mode selection
25 motor vehicle
26 data processing device
27 processor
28 data memory

1-10. (canceled)

11. A multifunctional operating device for a motor vehicle, comprising:
a multifunctional operating element for operating a plurality of different predefined functions, the functions including setting a volume for an acoustic output via a loudspeaker device and setting a driving experience,
wherein a driving operation mode of the motor vehicle and an ambience mode of the motor vehicle can be set using the operating element.

12. The multifunctional operating device of claim 11, wherein the operating device is configured to return to a standard operating mode after a predefined time period has elapsed starting with the respective last operation of a function that differs from the setting of the volume, wherein the volume can be set directly, if no further operation of the operating element or of a function that differs from the setting of the volume is carried out within the time period.

13. The multifunctional operating device of claim 11, further comprising a luminous element arranged at the operating element, wherein a respective light color of the luminous element is assigned to the different functions, and the operating device is configured to activate the luminous element, based on a respective function currently selected for operation, so as to be illuminated in the respective assigned light color.

14. The multifunctional operating device of claim 11, wherein the operating element can be actuated in a plurality of different manners, and the operating device is configured to switch between predefined functions in response to an actuation of the operating element in a first manner, and to switch between different predefined options or values of the respective currently selected function in response to an actuation of the operating element in a second manner.

15. The multifunctional operating device of claim 11, wherein the predefined functions are configured in a plurality of operating levels at each of which at least one of the functions can be operated, the operating element is embodied as a rotary/push button controller, and the operating device is configured to switch between the operating levels in response to a push actuation of the operating element along a predefined axis, to switch between a plurality of functions of the same respective currently selected operating level in response to a swiping actuation perpendicular to the predefined axis, and/or contact with a touch-sensitive region of the operating element, and to cycle through predefined options or values of the respective currently selected function in response to a rotary actuation of the operating element about the predefined axis.

16. The multifunctional operating device of claim 11, further comprising an infotainment display spaced apart from the operating element or, in the intended installation position in the motor vehicle, connected to an infotainment display of the motor vehicle, wherein the operating device is configured to generate a control signal corresponding to each actuation of the operating element, and to transmit this to the infotainment display to activate the same for visualizing a selection or setting effectuated by the respective actuation of the operating element.

17. The multifunctional operating device of claim 16, wherein the infotainment display is embodied as a touch screen, and the operating device is configured, in response to an actuation of the operating element, to activate the infotainment display for simultaneously displaying operating symbols for more than three predefined functions at an operating level selected by the actuation and/or for displaying operating symbols for more than three predefined options or values of the respective currently selected function.

18. The multifunctional operating device of claim 11, wherein the operating element comprises a display region, and the operating device is configured to activate the display region for visualizing a respective currently selected function and/or a respective current selection of an option or of a value of the currently selected function.

19. The operating device of claim 18, wherein the operating device is configured to visualize, via the display region, the respective function and/or the respective current selection of the option or of the value of the function simultaneously in the form of symbols and in the form of words.

20. A motor vehicle, comprising:
a multifunctional operating device, the operating device comprising:
a multifunctional operating element for operating a plurality of different predefined functions, the functions including setting a volume for an acoustic output via a loudspeaker device and setting a driving experience,
wherein a driving operation mode of the motor vehicle and an ambience mode of the motor vehicle can be set using the operating element.

21. The motor vehicle of claim 20, wherein the operating device is configured to return to a standard operating mode after a predefined time period has elapsed starting with the respective last operation of a function that differs from the setting of the volume, wherein the volume can be set directly, if no further operation of the operating element or of a function that differs from the setting of the volume is carried out within the time period.

22. The motor vehicle of claim 20, wherein the operating device further comprises a luminous element arranged at the operating element, wherein a respective light color of the luminous element is assigned to the different functions, and the operating device is configured to activate the luminous element, based on a respective function currently selected for operation, so as to be illuminated in the respective assigned light color.

23. The motor vehicle of claim 20, wherein the operating element can be actuated in a plurality of different manners, and the operating device is configured to switch between predefined functions in response to an actuation of the operating element in a first manner, and to switch between different predefined options or values of the respective currently selected function in response to an actuation of the operating element in a second manner.

24. The motor vehicle of claim 20, wherein the predefined functions are configured in a plurality of operating levels at each of which at least one of the functions can be operated, the operating element is embodied as a rotary/push button controller, and the operating device is configured to switch between the operating levels in response to a push actuation of the operating element along a predefined axis, to switch between a plurality of functions of the same respective currently selected operating level in response to a swiping actuation perpendicular to the predefined axis, and/or contact with a touch-sensitive region of the operating element, and to cycle through predefined options or values of the respective currently selected function in response to a rotary actuation of the operating element about the predefined axis.

25. The motor vehicle of claim 20, further comprising an infotainment display spaced apart from the operating element or, in the intended installation position in the motor vehicle, connected to an infotainment display of the motor vehicle, wherein the operating device is configured to generate a control signal corresponding to each actuation of the operating element, and to transmit this to the infotainment display to activate the same for visualizing a selection or setting effectuated by the respective actuation of the operating element.

26. The motor vehicle of claim 25, wherein the infotainment display is embodied as a touch screen, and the operating device is configured, in response to an actuation of the operating element, to activate the infotainment display for simultaneously displaying operating symbols for more than three predefined functions at an operating level selected by the actuation and/or for displaying operating symbols for more than three predefined options or values of the respective currently selected function.

27. The motor vehicle of claim 20, wherein the operating element comprises a display region, and the operating device is configured to activate the display region for visualizing a respective currently selected function and/or a respective current selection of an option or of a value of the currently selected function.

28. The motor vehicle of claim 27, wherein the operating device is configured to visualize, via the display region, the respective function and/or the respective current selection of the option or of the value of the function simultaneously in the form of symbols and in the form of words.

29. A multifunctional operating device for a motor vehicle, comprising:
a multifunctional operating element for operating a plurality of different predefined functions, the functions including setting a volume for an acoustic output via a loudspeaker device and setting a driving experience, wherein the operating element comprises a display region, and the operating device is configured to activate the display region for visualizing a respective currently selected function and/or a respective current selection of an option or of a value of the currently selected function, and
wherein a driving operation mode of the motor vehicle and an ambience mode of the motor vehicle can be set using the operating element.

30. The multifunctional operating device of claim 29, wherein the operating device is configured to visualize, via the display region, the respective function and/or the respective current selection of the option or of the value of the function simultaneously in the form of symbols and in the form of words.
